(19) United States
(12) Patent Application Publication
(10) Pub. No.: US 2023/0377033 A1
(43) Pub. Date: Nov. 23, 2023

(54) COMPUTER SYSTEM AND METHOD FOR SIMULATING LOAN PAYMENT STRUCTURE ON AN INTERACTIVE DISPLAY

(71) Applicant: Santander Consumer USA, Inc., Dallas, TX (US)

(72) Inventors: Courtney Hellums, Dallas, TX (US); Andrew Leemhuis, Dallas, TX (US); Kristen Demarjian, Dallas, TX (US); Amy Avers, Dallas, TX (US)

(73) Assignee: Santander Consumer USA, Inc., Dallas, TX (US)

(21) Appl. No.: 18/136,736

(22) Filed: Apr. 19, 2023

Related U.S. Application Data
(60) Provisional application No. 63/333,420, filed on Apr. 21, 2022.

(51) Int. Cl. G06Q 40/02

(52) U.S. Cl. CPC G06Q 40/02

(57) ABSTRACT

A computer system and method for generating a user interactive Graphical User Interface (GUI) on a display of a computer system for enabling performance of a loan based upon certain future borrower payment events. Accessed by a computer system is data from one or more network coupled databases relating to a loan assigned to a borrower. Through user interaction with the GUI, one or more simulations regarding performance of the loan is generated based upon one or more future borrower payment events. The GUI includes a graph having a user interactive slider associated with the borrower's payment whereby movement of the slider by a user alters the one or more simulations in accordance with slider movement. Displayed on the GUI are the results of the one or more simulations. The displayed results are modifiable by a user via user manipulation of one or more interactive tools provided on the GUI configured so as to alter one or more parameters regarding performance of the loan.

### CROSS REFERENCE TO RELATED APPLICATIONS

This application claims priority to U.S. Patent Application Ser. No. 63/333,420 filed Apr. 21, 2022 which is incorporated herein by reference in its entirety.

### 1. FIELD

### Background

The disclosed embodiments relate to simulating future performance of a loan structure based upon one or more payment events, and particularly to providing a customer service representative with an interactive tool for improving customer service relating to loan simulation based upon certain borrower loan payment strategies.

### 2. DESCRIPTION OF RELATED ART

It is widely accepted that an auto loan, amongst other types of loans (e.g., mortgages) is often a significant financial commitment for an individual/borrower. Efficient management of a borrower's finances regarding a borrower's loans has the potential to liberate substantial savings in interest and other fees and charges imposed by financial institutions. However, many loans contain a plethora of terms and conditions which must be balanced against available income, living expenses and discretionary spending, which by their nature are generally quite fluid and confusing to a borrower.

Accordingly it would be desirable to provide an Internet centric computer system for simulating performance of a loan, such as an auto loan, based on certain future payment events to enable a borrower to initiate well informed decisions on a future payment strategy for managing a loan, which could also be employed by borrowers to actively manage finances with the aim of reducing the overall cost of a loan where possible.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

Generally, the illustrated embodiments relate to an Internet centric computer system and method for simulating performance of a loan based upon certain future borrower payment events. Accessed, by an Internet centric computer system, is data relating to a loan assigned to a borrower. The computer system generates one or more simulations regarding performance of the loan based upon one or more future borrower payment events. Displayed by the computer system is graphical information on preferably an interactive User Interface (UI) indicating the one or more simulations.

In accordance with an illustrated embodiment, provided is a computer system and method for generating a user interactive Graphical User Interface (GUI) on a display of a computer system for enabling performance of a loan based upon certain future borrower payment events. Accessed by a computer system is data preferably from one or more network coupled databases relating to a loan assigned to a borrower. Through user interaction with the GUI, one or more simulations regarding performance of the loan is generated based upon one or more future borrower payment events. The GUI preferably includes a graph having a user interactive slider associated with the borrower's payment whereby movement of the slider by a user alters the one or more simulations in accordance with slider movement. Displayed on the GUI are the results of the one or more simulations. The displayed results are preferably modifiable by a user via user manipulation of one or more interactive tools provided on the GUI configured so as to alter one or more parameters regarding performance of the loan.

### BRIEF DESCRIPTION OF THE DRAWINGS

So that those skilled in the art to which the subject disclosure appertains will readily understand how to make and use the devices and methods of the subject disclosure without undue experimentation, illustrated embodiments thereof will be described in detail herein below with reference to certain figures, wherein:

FIG. 1 illustrates an example communication network in accordance with the illustrated embodiments;

FIG. 2 illustrates an example network device/node in accordance with the illustrated embodiments;

FIG. 3 illustrates a flowchart depicting a computer process/method to accordance with the illustrated embodiments; and

FIGS. 4 and 5 illustrate interactive User Interfaces (UIs) provided on a computing device display in accordance with the illustrated embodiments.

### DETAILED DESCRIPTION OF CERTAIN EMBODIMENTS

Aspects of the disclosed embodiments are illustrated in the following description and related drawings directed to specific illustrated embodiments. Alternate embodiment's may be devised without departing from the scope of the illustrated embodiments. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

Unless defined otherwise, all technical and scientific terms used herein have the same meaning as commonly understood by one of ordinary skill in the art to which the illustrated embodiments belong. Although any methods and materials similar or equivalent to those described herein can also be used in the practice or testing of the illustrated embodiments, exemplary methods and materials are now described. It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. The terminology used herein is for the purpose of describing particular embodiments only and is not intended to be limiting of the illustrated embodiments. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiment's may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described below. One skilled in the art will appreciate further features and advantages of the illustrated embodiments based on the below-described embodiments. Accordingly, the embodiments described herein are not to be limited by what has been particularly shown and described, except as indicated by the appended claims.

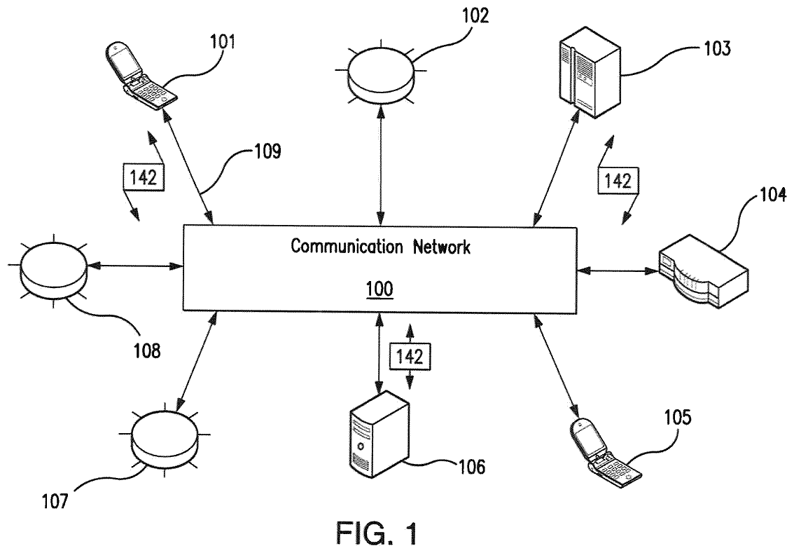

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, customer server agent computing devices 103, customer/borrower computing devices 104, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

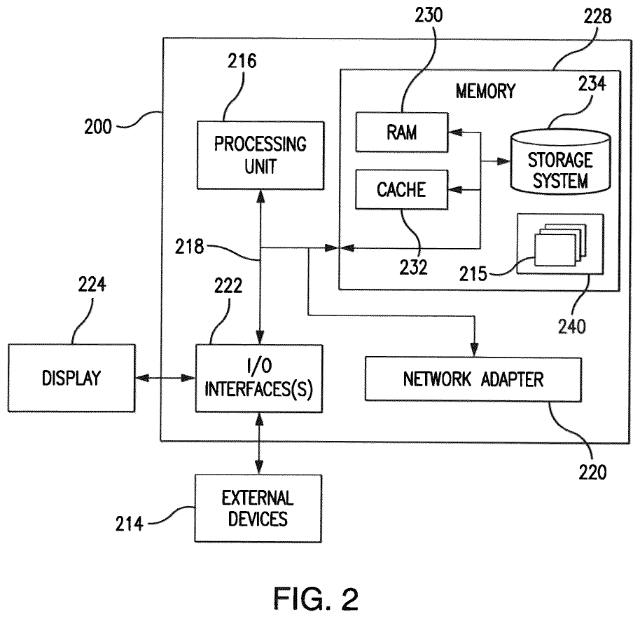

FIG. 2 is a schematic block diagram of an example network computing device 200 (e.g., customer service agent computing device 103, customer computing device 104, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of the present disclosure. Device 200 is only one example of a suitable system and is not intended to suggest any limitation as to the scope of use or functionality of embodiments of the disclosure described herein. Regardless, computing device 200 is capable of being implemented and/or performing any of the functionality set forth herein relating to simulating future performance of a loan based upon one or more payment events, and particularly for providing a customer service agent with an interactive tool for improving a UI provided to the customer service agent relating to loan simulation based upon certain customer loan payment strategies.

Computing device 200 is operational with numerous special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein relating to loan simulation.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present disclosure may be implemented. FIGS. 1 and 2 are exemplary of a suitable environment and are not intended to suggest any limitation as to the structure, scope of use, or functionality of an embodiment of the present disclosure. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With the exemplary communication network 100 (FIG. 1) and computing device 200 (FIG. 2) being generally shown and discussed above, description of certain illustrated embodiments will now be provided. Is it to be appreciated the centralized and automated loan servicing tool described in the illustrated embodiments provides a simulator tool enabling customer service agents to efficiently simulate a variety of future payment behavior scenarios to calculate a customer's balance at maturity based on the current financial position of the account. Customer service agents are able to modify payment behavior inputs to simulate a plurality of outcomes, and rapidly provide borrowers with alternative options for reducing their projected balance at maturity, such as by making payments earlier, increasing payments, or making a lump sum payment. The loan servicing tool of the illustrated embodiments provides an output (e.g., preferably via an interactive UI provided on a display of an Internet coupled computer associated with a customer service agent) of each simulation indicating the specific details of the allocation of each simulated future payment, which can be used to educate customers on portions of their payments that will be applied to interest, principal and/or fees, and how it impacts loan progress.

It is to be further appreciated the below description of the illustrated embodiments of the loan servicing tool 200 is described with particular reference to a customer service agent that both inputs information into the loan servicing tool 200 as well as views information relating to a borrower's loan on preferably an interactive User Interface (UI) preferably provided on a display (e.g., 224) associated with the computing device (e.g., 103) operated by the customer service agent. However, this illustrated embodiment is to be understood to be an exemplary embodiment, as the loan servicing tool 200 of the illustrated embodiments is not to be understood to be limited to this exemplary embodiment. For instance, it may also encompass enabling a borrower to also both input information into the loan servicing tool 200 as well as view information relating to a borrower's loan on a User Interface (UI) preferably provided on an interactive display (e.g., 224) associated with the Internet coupled computing device (e.g., 104) associated with the borrower. Additionally, while the illustrated embodiments are described regarding an auto loan associated with a borrower, the loan servicing tool 200 is not be understood to be limited to an auto loan as it may likewise be functional with many other types of applicable loans, including, but not limited to: personal loans; mortgage loans; student loans; home equity loans; and debt consolidation loans.

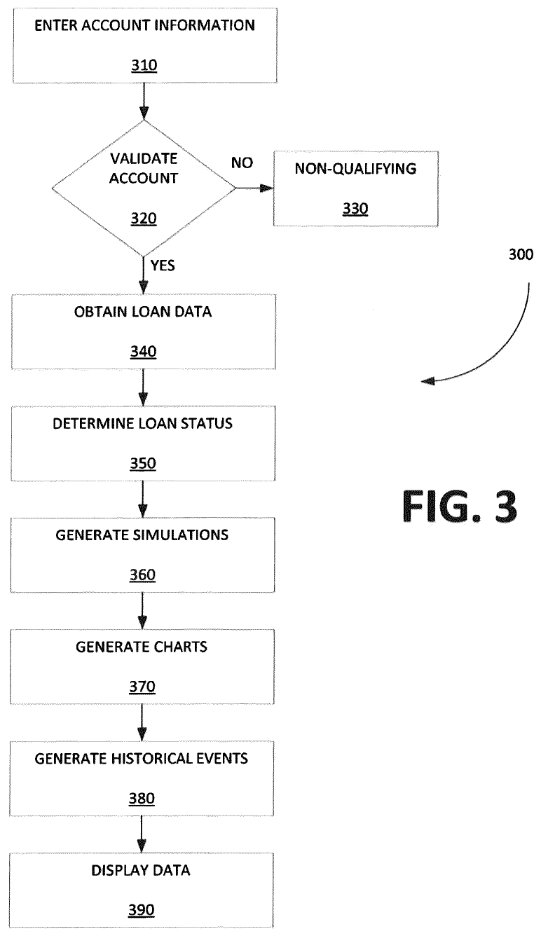

With reference now to FIG. 3, described is an exemplary method of operation (referenced generally by process 300) for the loan servicing tool 200 in accordance with the illustrated embodiments. Starting at step 310, a borrower's information (e.g., loan no.) relating to loan associated with the borrower (e.g., an auto loan) is entered into the loan servicing Internet coupled computer system 200 (hereinafter “system 200”) preferably via an Internet coupled computing device 103 associated with a customer service agent providing customer service to the borrower. At step 320, process 300 evaluates the loan, via the Internet coupled computer system 200, to determine if it qualifies for simulation. If not (e.g., the loan is/was subject to incompatible terms, paid off assets, bankruptcy, etc.), a message is preferably provided that the subject loan is not compatible for simulation determination/processing, step 330.

If yes (the loan qualifies for simulation, step 320) then at step 340 data is retrieved into the computer system 200 from one or more network coupled databases (e.g., database 234) having information relevant to the borrower's loan. It is noted this is particularly advantageous as electronic data regarding the borrower's loan may reside in numerous databases (which may be coupled in numerous computer networks) which is automatically retrieved and aggregated, via the network coupled computer system 200 (e.g., via a LAN and/or Internet) for centralized simulation by the process 300 of the illustrated embodiments. Additionally, it is also advantageous because using more generic information, such as that leveraged by existing online Internet centric tools, avoids utilization of consideration of financial treatment of the different components of a customer's balance, which often yields inaccurate results.

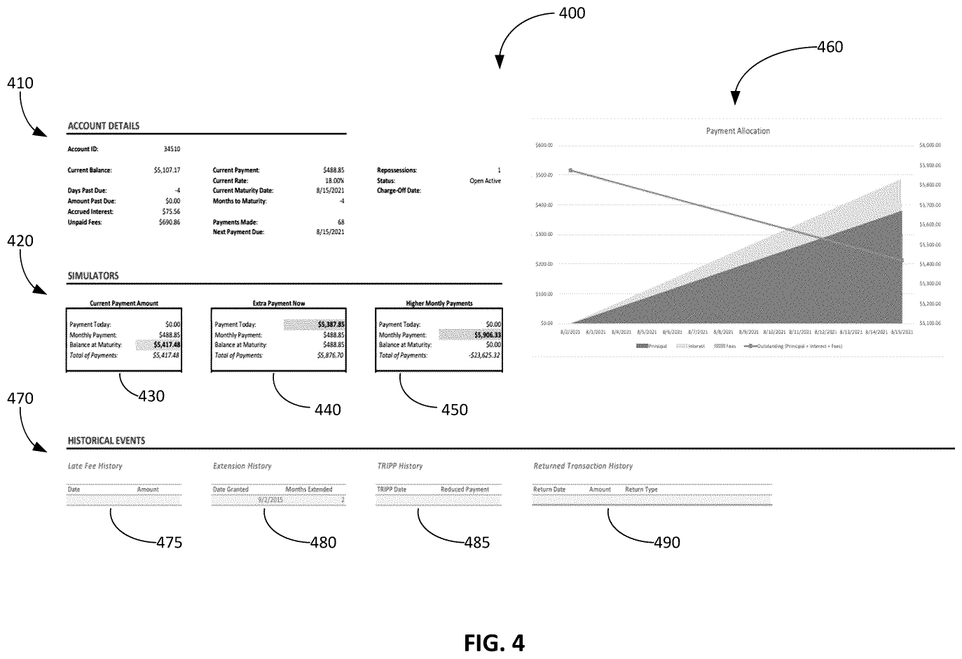

Next, step 350, preferably the current status of the loan is determined. For instance, determining the current status may include (but is not limited to): current account status (e.g., is it current?); current principal balance; unpaid accrued interest; unpaid fees; days past due; amount past due; monthly payment amount; interest rate; current maturity date; payments made; number of repossessions; charge off date; next due date; number of times loan was paid late (30, 60 and 90 days) and current per diem. As described below with reference to FIG. 4, a snapshot 410 of the determined current loan status is preferably provided in a UI 400 displayed on a display (e.g., 224) of a customer service agent's computing device (e.g., 103).

At step 360, the computer loan simulation tool 200 preferably generates (utilizing the retrieved aggregated loan data) one or more simulations regarding performance of the loan based upon one or more future borrower payment events. Preferably, each of the one or more simulations regarding performance of the loan that is contingent upon one or more future borrower payment events further includes generating default payment simulations so as to preferably display on the user interactive UI 400 loan information regarding: payment today, monthly payment, total of payments, and balance at maturity. For instance, in accordance with an illustrated embodiment, the loan simulation tool 200 automatically generates prescribed simulation scenarios such as (which the illustrated embodiments are not to be limited to):

### Scenario #1— Current Payment Amount (430)

This simulation includes determining the borrower's balance at maturity utilizing the criteria: borrower makes a payment on the current date to bring the loan account current (payment today); and borrower makes all contractual payments on the scheduled due date each remaining month until maturity (monthly payment).

### Scenario #2— Extra Payment Now (440)

This simulation includes determining what amount the borrower needs to make on the current date (payment today) to have a zero ($0) balance at maturity assuming all contractual payments are made on the scheduled due date each remaining month until maturity (monthly payment).

### Scenario #3— Higher Monthly Payments (450)

This simulation includes determining what amount the borrower needs to pay each month on their scheduled due date (monthly payment) to have a zero ($0) balance at maturity assuming the borrower pays the full amount past due on the current date (payment today).

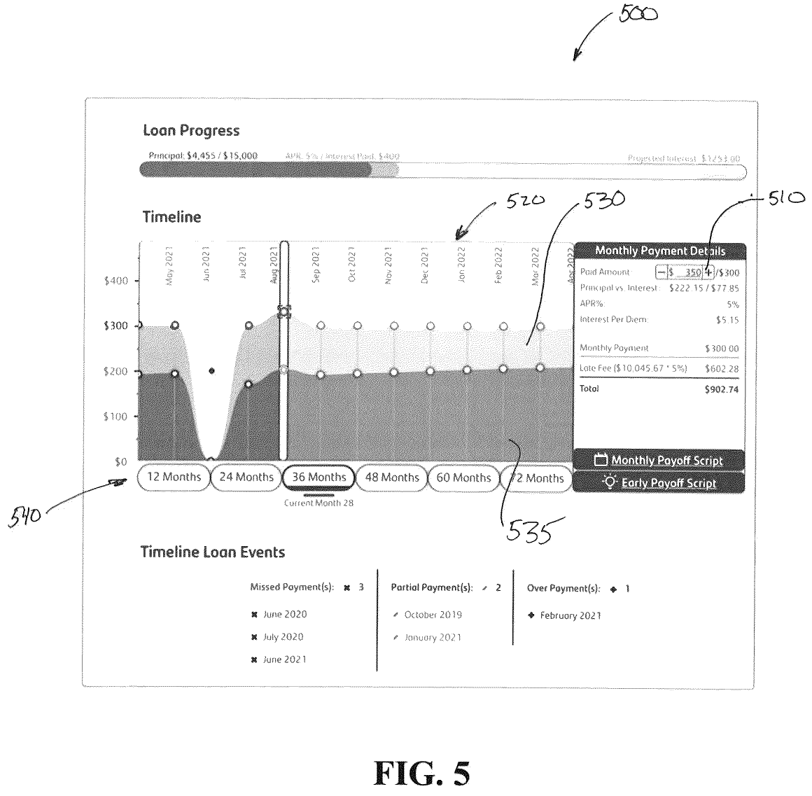

With reference now to FIG. 5, in accordance with other illustrated embodiments, the simulation tool 200 is also further configured and operational to, in addition and/or separate from the aforesaid three simulation scenarios (430-450), simulate different customized scenarios for future borrower payment behavior and to determine and display on an interactive UI 500 (preferably provided on a customer service representative display), the impact to the loan balance at maturity based on behavior that is appropriate to the payment allocation by providing a customer service agent with the ability to enter different amounts for the borrower to pay on the current date (payment today), and monthly on their scheduled due date for all remaining months (monthly payment). For instance, this includes: 1) the ability to simulate the borrower splitting the monthly payment amount into multiple equal payments distributed evenly throughout the month (options may be semi-monthly, bi-weekly, or weekly payments); 2) the ability to simulate the borrower making their monthly payment early each month on the day entered by a customer service agent; 3) calculating an early payoff date in the event a simulation is submitted that would pay off the loan before the current maturity date.

With continuing reference to UI 500 of FIG. 5, the simulation tool 200 enables a customer service representative to enter a customized payment amount (e.g., if the customer wanted to make increased payments) 510. Thus, simulation tool 200 is configured and operable to enable a customer service representative to enter a payment amount as indicated by a borrower, which then triggers generation and graphical indication reflecting this hypothetical scenario (e.g., graph 520). For instance, shaded region 535 indicates the portion of loan principal the hypothetical payment is applied too, while shaded region 530 indicates the portion of interest the hypothetical payment is applied too relative to a user selectable timeline 540 for the loan. A noted advantage is this automation process, via interactive UI's, significantly reduces customer call time because the customer service representative does not have to perform calculations, while also providing significant ease of data entry via the interactive UI's, which is also beneficial as it mitigates the potential for human error often associated with such human calculations. It is to be appreciated and understood, and with particular reference to FIG. 5, that the simulation tool 200 of the illustrated embodiments enables a user of the tool, via an intuitive interactive interface, the ability to navigate and use the functionalities of the simulation tool 200 without any formal training, which is a significant advantage over prior art techniques for simulating loan performance.

Returning now to FIG. 3, at step 370, the loan simulation tool 200 is also preferably configured and functional to generate, and output, a graph (e.g., 460, FIG. 4) displayed on UI 400 indicating the amount that will be applied to principal, interest, and fees for each payment for each simulation. For instance, and with reference to FIG. 4, when a user selects a generated simulation scenario (e.g., 430) displayed on the UI 400, such a graph (e.g., 460) is populated with the payment information from that selected simulation (e.g., 430). It is to be appreciated that certain illustrated embodiments may include an interactive slider associated with a displayed graph (e.g., 460) that is associated with a borrower's payment such that movement thereof by a user of the UI 400 will alter the current simulation in accordance with slider movement.

The loan simulation tool 400 (preferably utilizing the retrieved aggregated loan data, step 340) at step 380 preferably determines one or more historical events (e.g., 470 on UI 400) associated with the borrower's loan. For instance, such historical events may include (but is not to be understood to be limited to): late fee history (475); extension history (480); TRIPP history (485); and returned transaction history (490).

Once the aforesaid simulations and determinations of steps 350-380 are performed by process 300 of the loan simulation tool 200, and as shown in FIG. 4, the process preferably generates on a single UI displayed on a customer service agent's computing 103, a display preferably providing each of the aforesaid: Account Details (410); Loan Simulations 420 (it is noted FIG. 4 shows each of the loan simulations 430-450 simultaneously being displayed); a chart 460 indicating certain aforesaid details of a selected loan simulation (e.g., 430, 440 or 450); and certain historical events 470 associated with the borrower's loan. It is to be appreciated that providing this information in UI 400 regarding a borrower's loan is particularity advantageous, and an improvement over prior loan servicing tools, whereby it automatically retrieves, and aggregates, via Internet coupled devices, data relating to a borrower's loan to a centralized location/database to rapidly provide information regarding one or more future structures of the borrower's loan based upon various payment structures. It is to be further appreciated that the accuracy of the aforesaid simulations are achieved by using the customer's actual loan information and terms. It is noted this is because loan terms have a significant affect on the financial performance when a customer does not make the exact amount of the contractual payment on the exact due date. With regard to prior art tools/methods, they were not able to provide simulations based on those terms, such as compound vs simple interest, and the interest treatment for non-principal amounts, such as fees.

An additional advantage is it indicates the effects of late payments, extensions and other payment options (e.g., hardship modification programs) regarding the impact of a borrower's ability to pay a loan. Another noted advantage is simulating future payment behavior scenarios for calculating a borrower's balance at loan maturity based on the current financial position of the borrower's loan account. For instance, it enables customer service agents to modify borrower payment behavior to simulate outcomes, and providing borrowers with alternative options for reducing their projected balance at maturity (e.g., by making payments earlier, increasing payments and/or making lump sum payments).

It is to be understood the descriptions of the various illustrated embodiments have been presented for purposes of illustration, but are not intended to be exhaustive or limited to the embodiments disclosed. Many modifications and variations will be apparent to those of ordinary skill in the art without departing from the scope and spirit of the described embodiments. For instance, the loan servicing tool 200 may be further configured and operational to determine and display on the interactive UI 400 a display indicating the amounts applied to principal, interest and fees for a prescribed amount of last payments (e.g., 4 payments), and provide simulation indicating what amounts will be applied to principal, interest and fees for next payment based on the amount and date of payment provided by borrower. It may also further provide the ability to simulate extensions and determine, and display on the UI 400, the impact to the loan balance at maturity. Additionally, it may simulate the borrower receiving extensions in one-month increments up the lower of the max 1-time event limit or the remaining number allowed for the life of the loan. It may also display on the UI 400 the projected loan balance at maturity and projected loan maturity date contingent upon the borrower makes zero (0) payments during extension months, and then makes all remaining contractual payments on due dates. And it may be further operational and functional to generate modified loan terms aligned to approved program criteria.

In summary, various embodiments of the present illustrated embodiments disclose a novel approach for a centralized and automated loan servicing tool. As described above, the illustrated embodiments provide an improvement thorough the provision of an automated and centralized loan management tool and an interactive User Interface (UI) for simulating loan strategy based on certain future payment events. For instance, previously, customer service agents had to search multiple different systems to find information about customer accounts and perform manual calculations and generalized examples to try to assist a customer in understanding how loan payments are allocated and how payment behavior and assistance tools impact loans. For example, calculations for hardship modifications had to be completed manually whereby the disadvantages of this approach were that the scenarios provided to customers did not provide information about how their specific loan was affected by payment behavior and loan assistance, resulting in customers having a poor understanding of how much they would owe at maturity based on that activity and future payment behavior. Additionally, manual calculations are prone to error and do not facilitate a consistent message to customers across all customer service agents. In overcoming these disadvantages associated with the prior loan servicing tools, the centralized and automated loan servicing tool described in the illustrated embodiments provides a simulator tool enabling customer service agents to efficiently simulate a variety of future payment behavior scenarios to calculate what a customer's balance at maturity will be based on the current financial position of the account. Customer service agents are able to modify payment behavior inputs to simulate a plurality of outcomes, and rapidly provide borrowers with alternative options for reducing their projected balance at maturity, such as making payments earlier, increasing payments, or making a lump sum payment. The loan servicing tool of the illustrated embodiments provides an output (e.g., preferably via an interactive UI provided on a display associated with a customer service agent) of each simulation indicating the specific details of the allocation of each simulated future payment, which can be used to educate customers on how much of their payments will be applied to interest, principal and fees, and how that impacts their loan progress.

It is to be understood the various embodiments disclosed herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The flowchart and block diagrams in the figures illustrate the architecture, functionality, and operation of possible implementations of systems, methods and computer program products according to various embodiments of the present illustrated embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer process for generating a user interactive Graphical User Interface (GUI) on a display of a computer system for enabling performance of a loan based upon certain future borrower payment events, comprising:
accessing, by the computer system, data from one or more network coupled databases relating to a loan assigned to a borrower; and
generating, by the computer system, via user interaction with the GUI, one or more simulations regarding performance of the loan based upon one or more future borrower payment events enabled by the user interaction with the GUI; and
displaying, by the computer system, results of the one or more simulations on the GUI.

2. The computer process as recited in claim 1, further including enabling modification of the results displayed on the GUI by providing one or more interactive tools on the GUI configured to be manipulated by the user to alter one or more parameters regarding performance of the loan.

3. The computer process as recited in claim 2, further including determining, by the computer system, the current status of the loan so as to be displayed on the GUI, wherein the determined current status of the loan includes a snapshot of the loan displayed on the GUI, and wherein the snapshot includes one or more of the following loan items: current account status; current principal balance; unpaid accrued interest; unpaid fees; days past due; amount past due; monthly payment amount; interest rate; current maturity date; payments made; number of repossessions; charge off date; next due date; number of times loan was paid late (30, 60 and 90 days) and current per diem.

4. The computer process as recited in claim 1, wherein each of the one or more simulations regarding performance of the loan contingent upon one or more future borrower payment events further includes generating default payment simulations such that displayed on the GUI is loan information regarding: payment today, monthly payment, total of payments, and balance at maturity.

5. The computer process as recited in claim 4, wherein the simulation includes displaying the borrower's balance at maturity utilizing the criteria: borrower submits a payment on a current date to bring the loan account current (payment today); and borrower submits all contractual payments on a scheduled due date for each remaining month until maturity (monthly payment).

6. The computer process as recited in claim 5, wherein the simulation includes displaying an amount the borrower is required to submit on the current date (payment today) to have a zero ($0) balance at loan maturity contingent upon all contractual payments being timely submitted until loan maturity (monthly payment).

7. The computer process as recited in claim 6, wherein the simulation includes displaying on the GUI an amount the borrower is required to timely submit each month (monthly payment) to have a zero ($0) balance at maturity contingent upon the borrower submitting a full amount past due on a current date (payment today).

8. The computer process as recited in claim 7, wherein simultaneously displayed on the GUI is: 1) the borrower's balance at maturity when the borrower submits a payment on the current date to bring the loan account current; 2) the amount the borrower is required to submit on the current date to have a zero ($0) balance at maturity with all contractual payments being timely submitted until loan maturity (monthly payment); and 3) the amount the borrower is required to timely submit each month (monthly payment) to have a zero ($0) balance at maturity contingent upon the borrower submitting a full amount past due on the current date (payment today).

9. The computer process as recited in claim 1, wherein the one or more simulations includes simulating, via user manipulation of the interactive tools provided on the GUI, different scenarios for future borrower payment behavior to determine, and display on the GUI, the impact upon the loan balance at maturity based on behavior appropriate to the payment allocation.

10. The computer process as recited in claim 2, wherein the one or more interactive tools includes an interactive slider for the borrower's payment which movement thereof by a user of the UI will alter the current simulation in accordance with slider movement.

11. The computer process as recited in claim 10, wherein the GUI is provided on a display accessible by each of the borrower and a customer service agent associated with the loan.

12. The computer process as recited in 11, wherein each of the borrower and the customer service agent inputs data, via the GUI provided on their respective display, to initiate a simulation regarding performance of the loan.

13. The computer process as recited in claim 1, wherein the loan consists of a: personal loan; auto loan; student loan; home equity loan; and debt consolidation loan.

14. The computer process as recited in claim 1, wherein the GUI includes a graph having a user interactive slider for the borrower's payment which movement thereof by a user of the GUI alters the current simulation in accordance with slider movement.

15. A computer process for generating a user interactive Graphical User Interface (GUI) on a display of a computer system for simulating performance of a loan based upon certain future borrower payment events, comprising:
accessing, by the computer system, data from one or more network coupled databases relating to a loan assigned to a borrower;
determining, by the computer system, a current status of the loan; and
generating, by the computer system, via user interaction with the GUI, at least the following simulations regarding performance of the loan based upon one or more future borrower payment events contingent upon information inputted to the computer system:
indicating the borrower's balance at maturity utilizing the criteria: borrower submits a payment on a current date to bring the loan account current (payment today) and borrower submits all contractual payments on a scheduled due date each remaining month until maturity (monthly payment);
indicating an amount the borrower would need to submit on the current date to have a zero $0 balance at maturity contingent upon all contractual payments are submitted on the scheduled due date for each remaining month until maturity; and
indicating an amount the borrower would need to submit each month on a scheduled due date to have a zero ($0) balance at maturity contingent upon the borrower submits a full amount past due on the current date; and
displaying, by the computer system, results of the simulations regarding performance of the loan on the GUI.

16. The computer process as recited in claim 15, further including enabling modification of the results displayed on the GUI by providing one or more interactive tools on the GUI configured to be manipulated by the user to alter one or more parameters regarding performance of the loan.

17. The computer process as recited in claim 16, wherein the GUI includes a graph having a user interactive slider for the borrower's payment which movement thereof by a user of the UI will alter the current simulation in accordance with slider movement.

18. The computer process as recited in claim 17, wherein the GUI is provided on a display accessible by each of the borrower and a customer service agent associated with the loan.

19. The computer process as recited in 18, wherein each of the borrower and the customer service agent inputs data, via the GUI provided on their respective display, to initiate a simulation regarding performance of the loan.

20. A computer process for generating a user interactive Graphical User Interface (GUI) on a display of a computer system for enabling performance of a loan based upon certain future borrower payment events, comprising:
accessing, by the computer system, data from one or more network coupled databases relating to a loan assigned to a borrower; and
generating, by the computer system, via user interaction with the GUI, one or more simulations regarding performance of the loan based upon one or more future borrower payment events enabled by the user interaction with the GUI, wherein the GUI includes a graph having a user interactive slider associated with the borrower's payment whereby movement of the slider by a user alters the one or more simulations in accordance with slider movement;
displaying, by the computer system, results of the one or more simulations on the GUI; and
enabling, by the computer system, modification of the results displayed on the GUI by providing one or more interactive tools on the GUI configured to be manipulated by the user to alter one or more parameters regarding performance of the loan.
